(19) United States
(12) Patent Application Publication
(10) Pub. No.: US 2026/0351929 A1
(43) Pub. Date: Nov. 5, 2026

(54) CABLE PULLER

(71) Applicant: Harbor Freight Tools USA, Inc., Calabasas, CA (US)

(72) Inventor: John L. Miller, Boca Raton, FL (US)

(73) Assignee: Harbor Freight Tools USA, Inc., Calabasas, CA (US)

(21) Appl. No.: 19/664,550

(22) Filed: Apr. 30, 2026

Related U.S. Application Data
(60) Provisional application No. 63/797,906, filed on Apr. 30, 2025.

(51) Int. Cl. H02G 1/08

(52) U.S. Cl. CPC H02G 1/081

(57) ABSTRACT

At least one embodiment relates to a cable puller. The cable puller may include a housing including an inner cavity, a frame disposed within the inner cavity and dividing the inner cavity into a central cavity with a first outer cavity on a first side of the central cavity and a second outer cavity on a second side of the central cavity opposite the first side, a rotatable drum disposed within the central cavity, a motor disposed within the central cavity, a set of transfer gears coupled between the motor and the rotatable drum, the set of transfer gears disposed in one of the first outer cavity or the second outer cavity, and a planetary gear assembly coupled between the motor and the rotatable drum, the planetary gear assembly disposed in the other of the first outer cavity or the second outer cavity.

### CROSS REFERENCE TO RELATED PATENT APPLICATION

This application claims the benefit of and priority to U.S. Provisional Patent Application No. 63/797,906, filed Apr. 30, 2025, which is incorporated herein by reference in its entirety.

### BACKGROUND

Some pulling devices use a cable to pull loads towards a destination. For example, some pulling devices use a motor or a crank to rotate a drum, causing the cable to extend or retract. Some pulling devices may be large in volume and possess an uneven mass distribution, leading to difficulty for operators in carrying and transporting the pulling devices. Additionally, control interfaces of pulling devices may be positioned remote from where an operator is holding the device, causing difficulties relating to simultaneous securing and operating of the cable puller. Further, pulling devices may not include external access points to interior components, leading to challenges associated with performing repairs and maintenance.

### SUMMARY OF THE INVENTION

At least one embodiment relates to a cable puller. The cable puller may include a housing including an inner cavity, a frame disposed within the inner cavity and dividing the inner cavity into a central cavity with a first outer cavity on a first side of the central cavity and a second outer cavity on a second side of the central cavity opposite the first side, a rotatable drum disposed within the central cavity, a motor disposed within the central cavity, a set of transfer gears coupled between the motor and the rotatable drum, the set of transfer gears disposed in one of the first outer cavity or the second outer cavity, and a planetary gear assembly coupled between the motor and the rotatable drum, the planetary gear assembly disposed in the other of the first outer cavity or the second outer cavity.

In some embodiments, the motor may be disposed in a rear portion of the central cavity, and the rotatable drum is disposed in a front portion of the central cavity.

In some embodiments, the frame may include a first vertical plate and a second vertical plate extending a length of the inner cavity, and wherein the central cavity is positioned between the first vertical plate and the second vertical plate.

In some embodiments, the first vertical plate and the second vertical plate may each include one or more openings to allow the motor to couple to the set of transfer gears, the set of transfer gears to couple to the planetary gear assembly, and the planetary gear assembly to couple to the rotatable drum.

In some embodiments, the first outer cavity may be defined by a first distance extending laterally from the first vertical plate to a first wall of the inner cavity, and the second outer cavity is defined by a second distance extending laterally from the second vertical plate to a second wall of the inner cavity.

In some embodiments, the set of transfer gears may be coupled to the planetary gear assembly via a transfer shaft extending through the rotatable drum.

In some embodiments, the rotatable drum may include a channel extending between the first outer cavity and the second outer cavity.

In some embodiments, the transfer shaft may extend within the channel.

In some embodiments, the cable puller may include an access hatch disposed on a bottom portion of the housing to move between an open position and a closed position, and in the open position, the access hatch may facilitate access to the inner cavity.

In some embodiments, the motor is disposed in a front portion of the central cavity, and the rotatable drum is disposed in a rear portion of the central cavity, and a top surface of a base of the rotatable drum is positioned above a top surface of the motor.

At least one embodiment relates to a cable puller. The cable puller may include a housing including an inner cavity, a frame disposed within the inner cavity, a rotatable drum disposed within the inner cavity, a motor disposed within the inner cavity; a set of transfer gears coupled between the motor and the rotatable drum, the set of transfer gears disposed in the inner cavity, a planetary gear assembly coupled to the set of transfer gears via a transfer shaft extending through the rotatable drum and disposed in the inner cavity, and an access hatch disposed on a bottom portion of the housing and configured to move between an open position and a closed position, wherein the access hatch is configured to facilitate access to a portion of the inner cavity.

In some embodiments, the access hatch is decoupled from the housing in the open position.

In some embodiments, the access hatch is moveably coupled to the housing.

In some embodiments, the access hatch is at least partially aligned with the drum.

In some embodiments, the access hatch is removably coupled to the housing via a threaded fastener.

At least one embodiment relates to a cable puller. The cable puller may include a housing including an inner cavity. The inner cavity may include a rotatable drum, a motor; and a gear assembly coupling the motor to the rotatable drum. The cable puller may include a handle positioned on a top portion of the housing, the handle to be gripped by an operator, and a rocker switch positioned at a front portion of the handle and electronically coupled to the motor, wherein an actuation axis of the rocker switch is aligned with a longitudinal axis of the handle.

In some embodiments, the rocker switch may switch between a first position, a second position, and a third position, wherein the first position corresponds to movement of the motor in a first direction, the second position corresponds to the motor being in a neutral setting, and the third position corresponds to movement of the motor in a second direction.

In some embodiments, the cable puller may include an access hatch disposed on a bottom portion of the housing to move between an open position and a closed position, wherein responsive to the rocker switch being in the first position or the third position, the access hatch is locked in the closed position until the rocker switch is in the second position.

In some embodiments, the rocker switch may be positioned such that a hand of the operator used to grip the handle can simultaneously interact with the rocker switch.

In some embodiments, the cable puller may include a power switch to allow or restrict the motor from receiving electricity, wherein when the power switch is allowing the motor to receive the electricity, the access hatch is locked in the closed position.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a cross-sectional view of a cable puller, according to an exemplary embodiment.

FIG. 2 is another cross-sectional view of the cable puller of FIG. 1, according to an exemplary embodiment.

FIG. 3 is a cross-sectional view of a cable puller, according to another exemplary embodiment.

FIG. 4 is a cross-section view of a side of the cable puller of FIG. 3, according to another exemplary embodiment.

FIG. 5 is a block diagram of the cable puller of FIG. 1, according to an exemplary embodiment.

FIG. 6 is a perspective view of the cable puller of FIG. 1, according to an exemplary embodiment.

FIG. 7 is a perspective view of a handle of the cable puller of FIG. 1, according to an exemplary embodiment.

FIG. 8 is a rocker switch of the handle of FIG. 7, according to an exemplary embodiment.

FIG. 9 is a side view of the cable puller of FIG. 1, according to an exemplary embodiment.

FIG. 10 is a cross-sectional view of a bottom portion of the cable puller of FIG. 1, according to an exemplary embodiment.

FIG. 11 is a cross-section view of a side of the cable puller of FIG. 1, according to an exemplary embodiment.

### DETAILED DESCRIPTION

Before turning to the figures, which illustrate certain exemplary embodiments in detail, it should be understood the present application is not limited to the details or methodology set forth in the description or illustrated in the figures. It should also be understood the terminology is for the purpose of description only and should not be regarded as limiting.

Referring generally to the FIGURES, a cable puller is a pulling device that uses an electric motor to cause rotation of a drum, thereby causing a cable wrapped around the drum to extend (or loosen) and/or retract (or tighten) based on the direction of rotation of the drum. Various embodiments of cable pullers described herein possess key improvements over conventional pulling devices, such as improved compactness (e.g., reduced footprint), improved stability due to a more even distribution of mass, an improved controls interface, and an exterior access hatch for facilitating simplified device maintenance.

A cable puller described herein provides an arrangement of components that allows for an improved distribution of mass while providing a smaller overall device footprint. The cable puller includes a housing including an inner cavity. The inner cavity includes a frame that divides the inner cavity into a central cavity and two outer cavities. The central cavity includes a motor in a rear portion of the central cavity and a rotatable drum positioned or disposed in a front portion of the central cavity. The outer cavities include gear assemblies, such as a set of transfer gears and a planetary gear assembly positioned or disposed in opposite outer cavities that indirectly couple the motor and the drum. This arrangement of components allows heavier components to be positioned closer to the center of the cable puller, leading to a more evenly distributed mass.

The cable puller may provide an improved operator interface for controlling operation of the motor. The cable puller may include a handle that is aligned with a longitudinal axis of the cable puller, allowing for an operator to grip and hold the cable puller during operation. The handle may include a rocker switch positioned at a front portion of the handle. The rocker switch may have an actuation axis that is aligned with a longitudinal axis of the handle, thereby allowing the operator to interact with the rocker switch with the same hand that is being used to grip the handle.

The cable puller may include an access hatch positioned on the bottom of the housing, allowing an operator to easily access components within the inner cavity, such as the rotatable drum. The access hatch may allow for improved ease of performing maintenance on the cable puller, such as replacing or repairing damaged cables.

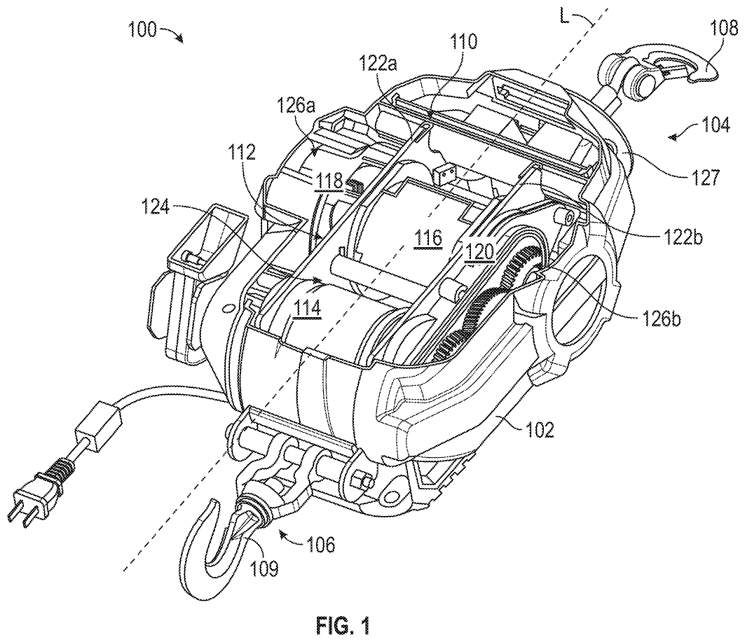

FIG. 1-11 illustrate a cable puller 100 (e.g., electric cable puller, pulling device, winch, cable tugger) according to various embodiments. The cable puller 100 includes a housing 102 (e.g., shell) configured to maintain (e.g., house, store) components (e.g., motors, gears, electronics, sensors, etc.) of the cable puller 100.

The housing 102 may define a length along a longitudinal centerline L. The housing 102 may include a front end 104 and a rear end 106 at each respective side of the housing 102 along the longitudinal centerline L. The cable puller 100 may include a front interface 108 (e.g., hook, hitch, etc.) protruding from the front end 104 for coupling to a load for pulling. The front interface 108 may be coupled to or include a cable of any given length for pulling the load towards the housing 102. In some embodiments, the cable puller 100 includes a disc 127 included with or coupled to the housing 102. The disc 127 may include an opening (e.g., hole), such that the cable can be fed through the disc 127 via the hole. The disc 127 may form a barrier between the front interface 108 and the housing 102, such that when the cable is fully retracted, the front interface 108 contacts the disc 127 and not a different portion of the housing 102. The cable puller 100 may include a rear interface 109 (e.g., hook, hitch, etc.) protruding from the rear end 106 to removably couple to a stationary object. For example, the rear interface 109 may include a hook to removably couple to an anchoring point of a wall or other stationary object, such that when the front interface 108 retracts (e.g., pulls) towards the housing 102, the housing 102 remains anchored.

As shown in FIG. 1, the housing 102 includes an inner cavity 110 for storing (e.g., housing) components (e.g., motors, gear assemblies, electronics, sensors, etc.) of the cable puller 100. The inner cavity 110 may include a frame 112 for securing (e.g., mounting) the components of the cable puller 100 within the inner cavity 110. For example, the frame 112 may be constructed around the components of the inner cavity 110, such that displacement of the components within the inner cavity 110 is restricted, regardless of movement of the cable puller 100.

The inner cavity 110 is shown to include a motor 114. The motor 114 may be an electric motor, such as an AC synchronous motor, brushless DC motors, or any other type of electric motor. The motor 114 may be capable of bidirectional rotation, such that the motor 114 can facilitate both inward and outward motion of the front interface 108 (e.g., by loosening or tightening the cable). The inner cavity 110 is shown to include a rotatable drum 116 (referred to herein as “drum 116”). The drum 116 may be rotatable responsive to rotation of the motor 114. For example, the drum 116 may be directly or indirectly rotatably coupled to the motor 114, such that when the motor 114 (or some component thereof, such as an output shaft) rotates, the drum 116 also rotates. As an example, responsive to rotation of the motor 114 in a clockwise direction, the drum 116 may rotate in the clockwise direction. As another example, responsive to rotation of the motor 114 in a counterclockwise direction, the drum 116 may rotate in the clockwise direction.

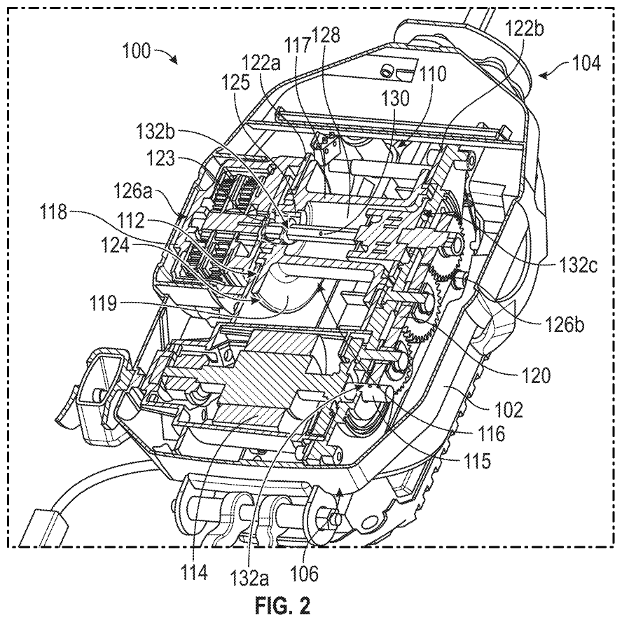

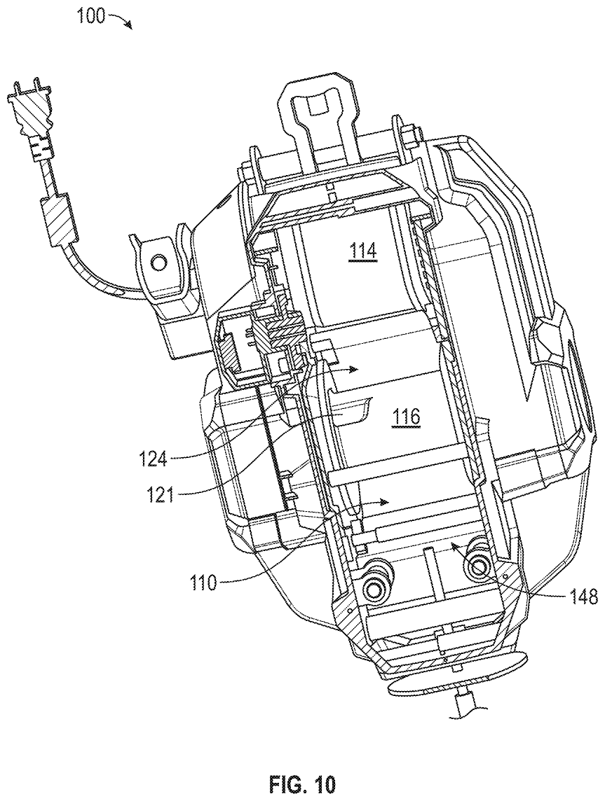

Referring to FIGS. 1 and 2, the drum 116 may be spool-shaped, such that the cable coupled to the front interface 108 may be accumulated (e.g., wound, wrapped) onto a surface of the drum 116. For example, the drum 116 may include a drum base 117 and two drum walls 119. The drum base 117 may be cylindrical shaped, and the drum walls 119 may be rounded (e.g., circular). The drum base 117 may have a smaller diameter than the drum walls 119, such that as the cable is wound (e.g., wrapped, looped, etc.) around the drum base 117, the cable can be contained within the drum walls 119. In some implementations, the length of the cable may be selected based on the diameter of the drum walls 119. For example, the length of the cable may be selected such that when the cable is fully wound around the drum base 117, the cable on the drum base 117 is located within an outer edge of the drum walls 119, specifically, the cable does not extend past the diameter of the drum walls 119. Responsive to rotation of the drum 116 (e.g., caused by the motor 114), the cable may be wrapped or unwrapped from around the drum base 117 (e.g., depending on the direction of rotation of the motor 114). The drum 116 (e.g., drum base 117) is shown to include a drum hole 121 (e.g., opening, slot, etc.) for securing the cable to the drum 116 (see, e.g., FIG. 10). In some embodiments, a first end of the cable may be passed (e.g., fed) through the drum hole 121, and secured to the drum 116 as the cable is looped around the drum base 117 over the first end of the cable. In some embodiments, the first end of the cable may be passed through the drum hole 121 and secured to the drum 116 with a set screw, not shown. The set screw may allow the first end of the cable to remain secured to the drum 116 when the cable is fully unwrapped (e.g., when the cable is not looped over the first end).

Referring to FIG. 1, the inner cavity 110 is shown to include a plurality of gear assemblies for facilitating rotation of the drum 116 responsive to rotation of the motor 114. In some embodiments, the inner cavity 110 includes a planetary gear assembly 118 coupled between the motor 114 and the drum 116. The planetary gear assembly 118 includes a plurality of gears to facilitate rotation of the drum 116 in a clockwise and/or counterclockwise direction. The planetary gear assembly 118 may directly or indirectly receive torque from the motor 114, and cause rotation of the drum 116. Additionally, or alternatively, the planetary gear assembly 118 may allow for the drum 116 to rotate responsive to the front interface 108 being pulled by an external force (e.g., operator), while the motor 114 is not causing rotation of the drum 116. For example, if an operator of the cable puller 100 is pulling on the front interface 108, the planetary gear assembly 118 may allow the drum 116 to rotate, thereby unwrapping the cable from the drum 116.

The inner cavity 110 is shown to include transfer gears 120 (e.g., a set of transfer gears, a transfer gear assembly) positioned between the motor 114 and the planetary gear assembly 118. The transfer gears 120 may facilitate the transfer of torque from the motor 114 to the planetary gear assembly 118 in cases where the dimensions (e.g., space, volume, shape, etc.) of the inner cavity 110 do not allow for direct coupling of the motor 114 and the planetary gear assembly 118. For example, the transfer gears 120 may include any number of gears arranged in any configuration capable of indirectly coupling the motor 114 (e.g., motor shaft) with the planetary gear assembly 118.

According to an example embodiment, the motor 114 may be disposed near the rear end 106, and the drum 116 may be disposed near the front end 104. Due to the arrangement of components within the inner cavity 110, the motor 114 (e.g., motor shaft may be unable to couple with the planetary gear assembly 118. As such, rotation of the motor 114 may be unable to directly cause rotation of the planetary gear assembly 118. The transfer gears 120 may be coupled between the planetary gear assembly 118 and the motor 114 (e.g., the motor 114 shaft). For example, the transfer gears 120 may include a first gear coupled to a motor shaft 115 of the motor 114, a second gear coupled to the planetary gear assembly 118. The transfer gears 120 may include one or more intermediate gears positioned between the first gear and the second gear, such that torque can be transferred from the motor 114, to the first gear, form the first gear to the intermediate gears, from the intermediate gears to the second gear, and from the second gear to the planetary gear assembly 118.

Referring to FIGS. 1 and 2, the components of the inner cavity 110 are arranged (e.g., disposed, positioned, coupled) to allow for improved compactness and stability of the cable puller 100. For example, to assist in ease of use for the operators of the cable puller 100, it may be desired for the housing 102 to be compact, and to have a center of mass near a center point of the cable puller 100 (e.g., along the longitudinal axis L).

To facilitate a center of mass along the longitudinal axis L, the frame 112 includes a first vertical plate 122a and a second vertical plate 122b (referred to collectively as “vertical plates 122”). The vertical plates 122 may be made from any metal or other material that can maintain components of the cable puller 100 within the inner cavity 110. The vertical plates 122 are shown to have a length approximately equal to or less than the length of the inner cavity 110 along the longitudinal axis L. The vertical plates 122 are shown to have a height approximately equal to or less than the height of the inner cavity 110. The vertical plates 122 may be positioned parallel or approximately parallel to the longitudinal axis L. The vertical plates 122 divide the inner cavity 110 into three cavities, referred to herein as a central cavity 124, a first outer cavity 126a on a first side of the central cavity 124, and a second outer cavity 126b on a second side of the central cavity 124 opposite the first side.

The central cavity 124 is defined as the space of the inner cavity 110 between the first vertical plate 122a and the second vertical plate 122b. To achieve a center of mass near the center point of the cable puller 100, it may be beneficial for the central cavity 124 to house (e.g., store, hold, contain) components with the largest relative mass, such that heavier components are closer to the longitudinal axis L. As a result, the central cavity 124 is shown to house the motor 114 and the drum 116. To achieve a center of mass that is near the center of the cable puller 100, the drum 116 is disposed in a front portion of the central cavity 124 near the front end 104 of the housing 102, and the motor 114 is disposed in a rear portion of the central cavity 124 near the read end 106 of the housing 102. The drum 116 and the motor 114 may have a length that is approximately equal to the space between the vertical plates 122, such that the drum 116 and the motor 114 can mount into or between one or more of the vertical plates 122. The drum 116 may be positioned in the front portion of the central cavity 124 such that the cable can be wrapped around and/or released from the drum 116 without interfering with other components of the central cavity 124. The motor 114 may be disposed in the rear portion of the central cavity 124 such that the mass of the motor 114 can act as a balance to the mass of the drum 116 and cable.

The first outer cavity 126a of the inner cavity 110 is defined by a distance extending laterally from the first vertical plate 122a to a first wall (e.g., side wall) of the inner cavity 110. The second outer cavity 126b is defined by a distance extending laterally from the second vertical plate 122b to an opposite wall (e.g., second wall, side wall) of the inner cavity 110. To achieve a center of mass within the inner cavity 110 nearest to the center of the cable puller 100, and to improve the compactness of the cable puller 100, the planetary gear assembly 118 is disposed in one of the first outer cavity 126a or the second outer cavity 126b, and the transfer gears 120 are disposed in the other of the first outer cavity 126a and the second outer cavity 126b. For example, as shown in FIG. 1 the planetary gear assembly 118 is disposed in the first outer cavity 126a and the transfer gears 120 are disposed in the second outer cavity 126b. The transfer gears 120 and the planetary gear assembly 118 may be disposed in opposite outer cavities 126 such that their masses counteract one another, leading to a center of mass that is closer to the center of the cable puller 100. The size of the first outer cavity 126a or the second outer cavity 126b may be approximately equal to the size of the planetary gear assembly 118 or a width of the transfer gears 120, respectively. Accordingly, the planetary gear assembly 118 and the transfer gears 120 may be mounted into or adjacent to the vertical plates 122 and extend laterally to approximately from a respective one of the vertical plates 122 to a wall of the inner cavity 110.

Still referring to FIGS. 1 and 2, the aforementioned arrangement of components within the inner cavity 110, although improving cable puller 100 compactness and center of mass, presents certain challenges associated with the coupling of components in such a way that components do not interfere with one another within the inner cavity 110. For example, while the transfer gears 120 are meant to indirectly couple the motor 114 and the planetary gear assembly 118, the motor 114 is disposed in the rear portion of the central cavity 124, and the transfer gears 120 and the planetary gear assembly 118 are each disposed in opposite outer cavities 126. Accordingly, the transfer gears 120 and the planetary gear assembly 118 must be coupled though the width of the central cavity 124, without interfering with operation of components within the central cavity 124 (e.g., motor 114, drum 116). As an example, the transfer gears 120 positioned in the second outer cavity 126b may couple with the planetary gear assembly 118 positioned in the first outer cavity 126a. However, the drum 116 may be positioned between the transfer gears 120 and the planetary gear assembly 118. As such, the cable puller 100 may facilitate coupling between the transfer gears 120 and the planetary gear assembly 118 without interfering with rotation of the drum 116.

Referring to FIG. 2, the vertical plates 122 are shown to include one or more openings 132 (e.g., holes, cuts, gaps, mounting points, etc.) to allow for coupling of components between the central cavity 124 and the outer cavities 126. For example, the vertical plates 122 may include an opening 132a to allow the motor shaft 115 of the motor 114 to couple with the transfer gears 120 in the second outer cavity 126b. As another example, the vertical plates 122 may include one or more openings 132b to allow the planetary gear assembly 118 to couple to the drum 116 in the first outer cavity 126a. As yet another example, the vertical plates 122 may include one or more openings 132c to allow the transfer gears 120 to couple to the planetary gear assembly 118 (e.g., through the central cavity 124 and one of the openings 132b).

To allow coupling between the transfer gears 120 and the planetary gear assembly 118 without interfering with the components of the central cavity 124 (e.g., motor 114, drum 116), the drum base 117 includes a channel 128 (e.g., opening) extending through a length of the drum 116 (e.g., a length of the central cavity 124). The channel 128 is shown to extend between the first outer cavity 126a and the second outer cavity 126b. For example, the channel 128 may extend from the transfer gears 120 to the planetary gear assembly 118. The transfer gears 120 and the planetary gear assembly 118 are coupled via a transfer shaft 130 extending through the drum 116. The transfer shaft 130 may be sized to extend through the channel 128 without directly contacting the drum 116 (e.g., and without interfering with rotation of the drum 116). This may allow for coupling of the planetary gear assembly 118 and the transfer gears 120 without interfering with extension/retraction of the cable.

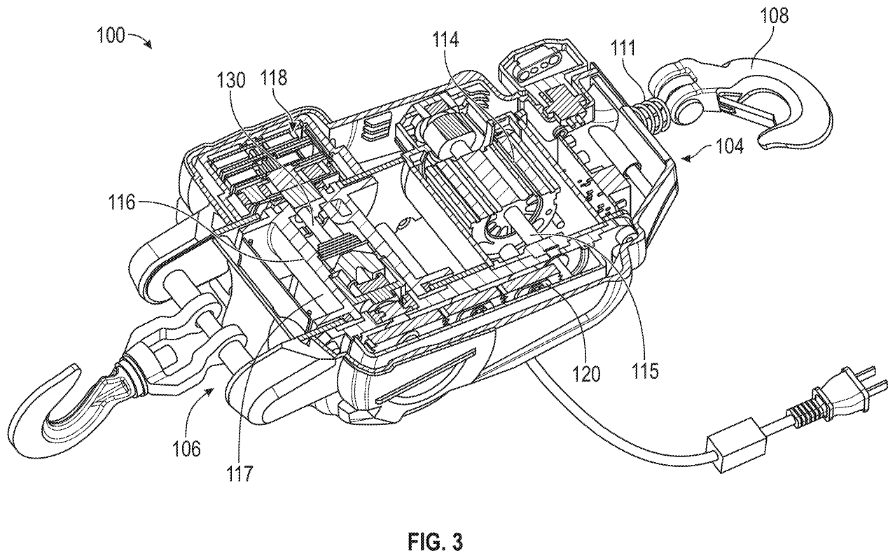

FIG. 3 illustrates the cable puller 100, in accordance with some embodiments. As shown, the cable puller 100 includes the motor 114 positioned near the front end 104 and the drum 116 positioned near the rear end 106. Similar to the cable puller 100 described with reference to FIGS. 1 and 2, the motor 114 (e.g., the motor shaft 115) and the planetary gear assembly 118 are coupled via the transfer gears 120. For example, the motor shaft 115 may be coupled with the transfer gears 120, and the transfer gears 120 may be coupled to the planetary gear assembly 118 via the transfer shaft 130 extended through the drum 116.

Referring to FIGS. 1 and 3, the position of the drum 116 within the cable puller 100 may impact its internal mass distribution. When the drum 116 is positioned in front of the motor 114 (e.g., closer to the front end 104), a portion of the rotating mass of the cable puller 100 is positioned near the front end 104. As the drum 116 is rotated and the cable extends or retracts, the mass of the drum 116 may change due to more or less of the cable being looped around the drum 116. As a result, the mass distribution of the cable puller 100 at the front end 104 may shift. When the drum 116 is positioned behind the motor 114 (e.g., closer to the rear end 106), a portion of the rotating mass of the cable puller 100 is positioned near the rear end 106. As the drum 116 is rotated and the cable extends or retracts, the mass of the drum 116 may change due to more or less of the cable being looped around the drum 116. As a result, the mass distribution of the cable puller 100 at the rear end 106 may shift.

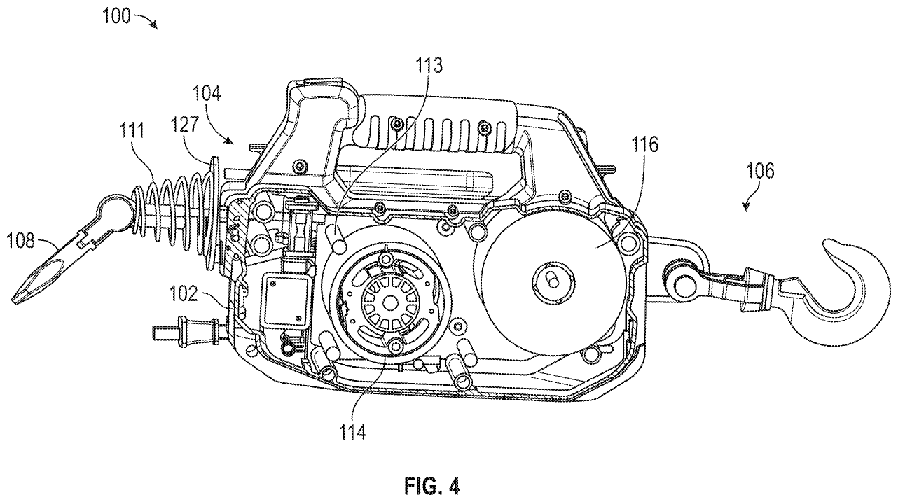

Referring to FIGS. 3 and 4, when the drum 116 is positioned near the rear end 106 and the motor 114 is positioned near the front end 104, the motor 114 may be positioned between the drum 116 and the front interface 108. As such, the cable may need to extend through the cable puller 100 past the motor 114 without interfering with operation of the motor 114. In some embodiments, the motor 114 and the drum 116 may be arranged within the cable puller 100 such that a top surface of the drum base 117 is positioned above a top surface of the motor 114. As such, the cable may extend from the top surface of the drum base 117 to the front interface 108 over the top surface of the motor 114.

In some embodiments, the cable puller 100 includes one or more guide surfaces 113 to prevent the cable from interacting with (e.g., touching, interfering with) the motor 114 and/or to help the operator operate (e.g., hold, maneuver) the cable puller 100. The one or more guide surfaces 113 may guide the cable through the cable puller 100 along a predetermined path from the drum 116 towards the front interface 108. For example, a guide surface 113 may be positioned around the outer surface of the motor 114 such that as the cable moves through the cable puller 100, the cable can contact the one or more guide surfaces 113 on a side of the guide surface 113 opposite the outer surface of the motor 114 and is restricted from contacting the motor 114. As another example, a guide surface 113 may be positioned a predetermined height above the drum base 117, such that the cable is restricted from being raised by more than the predetermined height above the drum base 117.

Referring to FIG. 3, there may be certain advantages associated with positioning the motor 114 in front of the drum 116 (e.g., closer to the front end 104). For example, the motor 114 may be positioned such that the top surface of the motor 114 is below the top surface of the drum base 117, which may lower the center of gravity of the cable puller 100 towards the bottom surface of the cable puller 100. A lower center of gravity may assist in maintaining the cable puller 100 in an upright orientation (e.g., the handle 136 remains upright) while the cable puller 100 is under tension. For example, while the cable puller is under tension, if the center of gravity were to be in an upper portion of the cable puller 100, the cable puller 100 may be more susceptible to unintentional flipping (e.g., rotation around the longitudinal axis L). Instead, the center of gravity being closer to the bottom surface of the cable puller may assist in maintaining the cable puller 100 in the upright orientation.

As the cable is released from (e.g., wound off) the drum 116, the center of gravity of the cable puller 100 may shift toward the motor 114 and/or the middle of the cable puller 100 due to the mass of the drum 116 decreasing. Advantageously, as the center of gravity moves toward the middle of the cable puller 100, the cable puller 100 may be more balanced and therefore easier for the operator to operate (e.g., hold, maneuver). As described above, in this arrangement, the top of the drum 116 may be positioned higher within the cable puller 100 than the motor 114. This may result in additional clearance (e.g., space) between the cable and the top surface of the motor 114, thereby reducing a likelihood of accidental interaction between the motor 114 and the cable.

With the motor 114 in front of the drum 116 (e.g., closer to the front end 104), there may be one or more additional guide surfaces 113 included to further support the cable within the housing 102. Advantageously, the one or more additional guide surfaces 113 may enhance the user operation by providing the operator with better control over the cable and/or cable puller 100 (e.g., relative to a cable puller 100 without the one or more additional guide surfaces 113).

Referring to FIG. 1, there may be certain advantages associated with positioning the drum 116 in front of the motor 114 (e.g., closer to the front end 104) rather than behind the motor 114. For example, placing the drum 116 closer to the front end 104 results in a reduced distance between the front interface 108 and the drum 116. As such, the total amount of cable needed to extend to an object outside of the cable puller 100 may be less than if the motor 114 was in front of the drum 116. Advantageously, this may reduce the total weight and/or manufacturing cost of the cable puller 100 due to less cable being needed. In some instances, placing the drum 116 closer to the front end 104 may allow for visual feedback to the operator regarding the cable around the drum 116. For example, the operator may be able to view the drum 116 through an opening on the front end 104 of the cable puller 100, and may therefore be able to view an amount of cable left on the drum or if the cable is jammed within the cable puller 100.

In some embodiments, the cable puller 100 includes a spring 111 or other cushioning mechanism between the front interface 108 and the housing 102 (e.g., the disc 127). The spring 111 may prevent damage from occurring due to the cable being retracted such that the front interface 108 contacts the housing 102. For example, the spring 111 may have a predetermined stiffness such that when the front interface 108 contacts the spring 111, the front interface 108 is prevented from contacting the housing 102, even if the motor 114 attempts to retract the cable further into the housing 102 than permissible. As another example, the spring 111 may have a predetermined stiffness and/or shape such that when the front interface 108 contacts the spring 111, the spring 111 restricts the front interface 108 from applying enough force or stress to the housing 102 to damage the front interface 108 or the housing 102. The spring 111 may have any shape and/or be constructed of metal or any other durable material capable of reducing the force or stress between the front interface 108 and the housing 102.

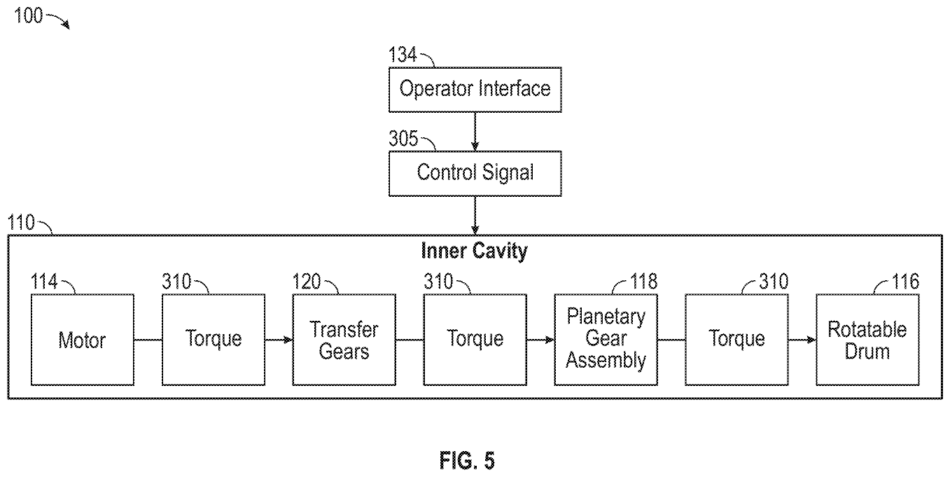

Referring to FIGS. 2 and 5, a torque 310 generated by operation of the motor 114 is transferred throughout the components of the inner cavity 110 to cause rotation of the drum 116, thereby causing the cable (e.g., and the front interface 108) to extend and/or retract. The cable puller 100 includes an operator interface 134 to transmit a control signal 305 to the inner cavity 110, the control signal 305 causing operation of the motor 114. The operator interface 134 may be any interface that the operator of the cable puller 100 can interact with to transmit the control signal 305. For example, the operator interface 134 may include a switch, such as a rocker switch. Additionally, or alternatively, the operator interface 134 may include a button, a virtual display, a joystick, or any other interface. The operator interface 134 may be disposed on the housing 102 or may be remote of the cable puller 100.

The motor 114 may include hardware and/or software components (e.g., motor controllers) configured to receive and process the control signal 305. For example, the control signal 305 may indicate to the motor 114 a desired direction of rotation of the motor shaft 115. The control signal 305 may cause the motor shaft 115 to rotate clockwise, counterclockwise, or to disable rotation of the motor shaft 115. As shown, the motor shaft 115 is coupled to the transfer gears 120 via the opening 132a. As the motor shaft 115 rotates, the torque 310 is transferred from the motor 114 to the transfer gears 120. The transfer gears 120 may be configured to rotate, and cause rotation of the transfer shaft 130.

As shown, the transfer gears 120 and the planetary gear assembly 118 are coupled via the transfer shaft 130. As the transfer gears 120 cause rotation of the transfer shaft 130, the torque 310 is transferred from the transfer gears 120 to the planetary gear assembly 118, causing rotation of the gears of the planetary gear assembly 118. The drum 116 is shown to be coupled to the planetary gear assembly 118 through the opening 132b via a gear 123 (e.g., central gear, connecting gear, sun gear, etc.). The gear 123 may be part of the planetary gear assembly 118 or may be separate from the planetary gear assembly 118. The drum 116 includes a section or collar having slots 125 to receive the teeth of the gear 123, such that rotation of the gear 123 causes the teeth to engage the slots 125 and thereby causes corresponding rotation in the drum 116. In other embodiments, the gear 123 may be fixedly or integrally coupled with the drum 116, such that the gear 123 and the drum 116 rotate together. For example, the gear 123 may transition to a shaft or tube fixedly coupled to the drum 116. In each embodiment, as the gears of the planetary gear assembly 118 rotate, the torque 310 is transferred from the gear 123 to the drum 116, causing the drum 116 to rotate. Based on the direction of rotation of the drum 116, the cable may be released from around the drum base 117, or may be accumulated on (e.g., wrapped around) the drum base 117.

In some embodiments, the planetary gear assembly 118 adjusts a magnitude of the torque 310 before transferring the torque 310 to the drum 116. This may ensure that the rotation of the drum 116 is causing the cable to be pulled at a desired torque, which can be different than the magnitude of the torque 310 provided by the motor 114. In some embodiments, the planetary gear assembly 118 may adjust the torque 310 based on limitations of the motor 114. For example, if the torque 310 provided by the motor 114 is too small for moving an object coupled to the cable puller 100 (e.g., via front interface 108), the planetary gear assembly 118 may increase the magnitude of the torque 310, and subsequently provide the torque 310 to the drum 116, thereby ensuring that the object can be moved by the cable puller 100. In some embodiments, the planetary gear assembly 118 may adjust the torque 310 based on limitations of the cable. For example, if the torque provided by the motor 114 is too large for the cable (e.g., such that it may damage the cable), the planetary gear assembly 118 may reduce the magnitude of the torque 310, and subsequently provide the torque 310 to the drum 116, thereby ensuring that the cable and/or the load is not damaged while being pulled.

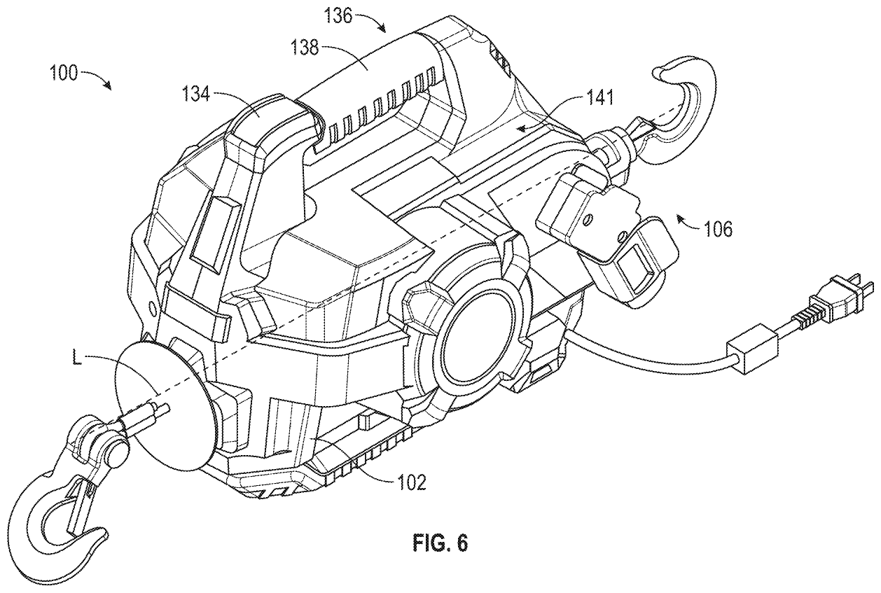

FIG. 6 illustrates the housing 102 of the cable puller 100. The housing 102 is shown to define a handle 136 positioned on a top portion 141 of the housing 102. The handle 136 is shaped to allow for the handle 136 to be gripped by the operator of the cable puller 100. The handle 136 may include a handle shaft 138. The handle shaft 138 may be sized and shaped such that the operator can grip (e.g., hold) the handle shaft 138 using a single hand. For example, the length and thickness of the handle shaft 138 may be based on an average hand size. The handle 136 defines a space below the handle shaft 138 and the top portion 141 to allow the operator to fully grasp the handle shaft 138. For example, the operator may place the palm of their hand on the top of the handle shaft 138 and curl their fingers entirely around the handle shaft 138.

To allow for ease of use and operator stability while gripping the handle 136, the handle 136 has a handle axis approximately parallel to the longitudinal axis L. This may allow for the operator to hold the handle shaft 138 directly above the center of mass of the cable puller 100, thereby improving the stability of the cable puller 100 while in operation or carrying the cable puller 100 from location to another location during non-operational periods.

Referring to FIG. 6-8, to further improve ease of use, the operator interface 134 is shown to be a rocker switch 134 positioned at a front portion of the handle 136. The rocker switch 134 has an actuation axis 145 that is aligned with (e.g., within ±15° from parallel with) the longitudinal axis L (e.g., and/or the longitudinal axis of the handle 136). The rocker switch 134 can be moved or toggled forward or backward along the actuation axis 145 to control operation of the cable puller 100. This allows for the operator to operate the rocker switch 134 with the same hand that is being used to grip the handle shaft 138. For example, the operator may grip the handle shaft 138 and simultaneously use their thumb to interact with (e.g., actuate and/or control) the rocker switch 134. The orientation of the rocker switch 134 also allows for intuitive operation by the operator. For example, to extend or unwind the cable from the drum 116, the operator may move (e.g., push) the rocker switch 134 away from the operator, and to retract or wind the cable onto the drum 116, the operator may move (e.g., push) the rocker switch 134 toward the operator. In other words, the direction in which the cable moves relative to the cable puller 100 may generally correspond to the direction in which the rocker switch 134 is moved by the operator. Some cable pullers may include an interface with an actuation axis that is not aligned with the handle axis, which may require the use of multiple hands to operate the cable puller and may not be intuitive for operation. For example, some cable pullers may include a support handle to be gripped by the operator with one hand, and a crank handle to be rotated by the operator with a second hand to facilitate rotation of the drum. Alternatively, the rocker switch 134 may allow for single-handed, intuitive operation of the cable puller 100, which can result in improved user-friendliness.

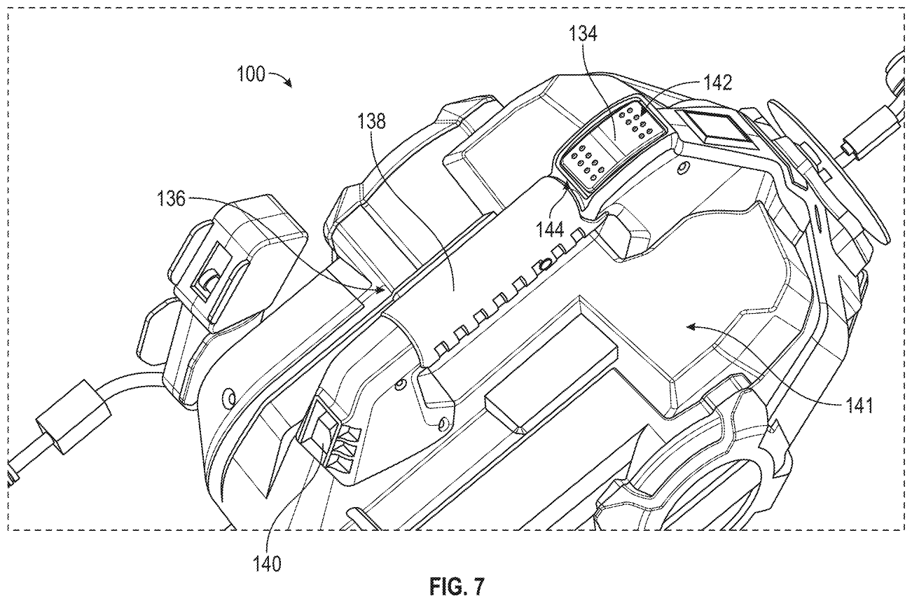

Referring to FIG. 7, the handle 136 is shown to include a power switch 140. The power switch 140 may enable and/or restrict the cable puller 100 from receiving electricity (e.g., from a battery, from an electrical outlet, etc.), regardless of the position of the rocker switch 134. The power switch 140 may be able to switch between two positions. When the power switch 140 is in a first position (e.g., on-position), the cable puller 100 is able (e.g., allowed) to receive electricity to operate the motor 114. When the power switch 140 is in a second position (e.g., off-position), the cable puller 100 may be unable to receive (e.g., restricted from receiving) electricity to operate the motor 114. For example, when the power switch 140 is in the second position, the motor 114 may not operate responsive to the operator interacting with the rocker switch 134.

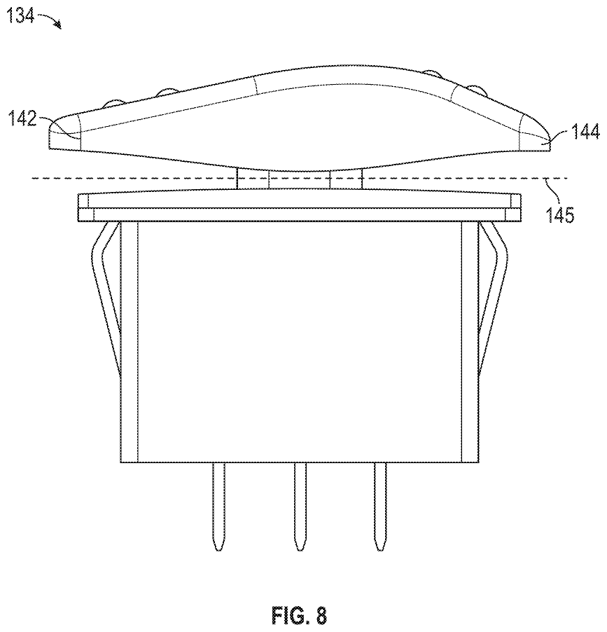

Referring to FIGS. 7 and 8, the rocker switch 134 includes a front end 142 and a rear end 144. The rocker switch 134 is adjustable between three positions, each position corresponding to an operation of the motor 114. For example, when the front end 142 is positioned below the actuation axis 145 of the rocker switch 134, the motor 114 may be in a first mode of operation. As another example, when the rear end 144 of the rocker switch 134 is positioned below the actuation axis 145, the motor 114 may be in a second mode of operation. As yet another example, when both the front end 142 and the rear end 144 are positioned on or above the actuation axis 145, the motor 114 may be in a third mode of operation.

While the rocker switch 134 is described with respect to the cable puller 100 shown in FIGS. 6 and 7, the rocker switch 134 and corresponding structure may be included in any embodiment, including the cable puller 100 shown in FIGS. 3 and 4.

The modes of operation of the motor 114 may correspond to a direction of rotation of the drum 116. For example, when the motor 114 is in the first mode of operation, the motor shaft 115 may rotate such that the drum 116 releases the cable. As another example, when the motor 114 is in the second mode of operation, the motor shaft 115 may rotate such that the drum 116 pulls the cable (e.g., to accumulate the cable around the drum base 117). As yet another example, when the motor 114 is in the third mode of operation, the motor shaft 115 may not rotate in either direction, causing the drum 116 to remain stationary (e.g., unless the cable is pulled by an external force).

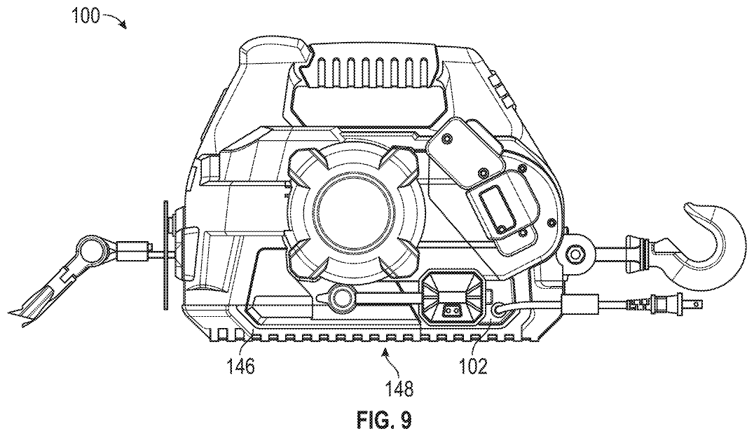

Referring to FIG. 9, the housing 102 is shown to include an access hatch 146 disposed on a bottom portion 148 of the housing 102. The access hatch 146 may be positioned at part of the bottom portion 148 of the housing 102, or may include the entire bottom portion 148 of the housing 102. The access hatch 146 may be moveable between an open position and a closed position relative to the housing 102 to facilitate access to at least a portion of the inner cavity 110 for configuration, maintenance, and repair of the cable puller 100. For example, the access hatch 146 may be capable of sliding from the housing 102 along a set of rails of the housing 102 to move between the open and closed positions. In some embodiments, the access hatch 146 is removably coupled to the housing 102. For example, the access hatch 146 may be coupled to the housing 102 via one or more attachment tabs (e.g., attachment tab 150) and/or one or more fasteners (e.g., screws), as further described herein. In such embodiments, the access hatch 146 may be coupled to the housing 102 in the closed position, and decoupled from the housing 102 in the open position. In other embodiments, the access hatch 146 is coupled or retained in both the closed position and the open position. For example, the access hatch 146 may be a door coupled to the housing 102 by one or more hinges, and be capable of pivoting about the hinges to open and close. It should be understood that, in various embodiments, the access hatch 146 may be capable of coupling and/or decoupling with the housing 102 in a variety of different ways including releasable tabs, fasteners, clips, or other means of attachment.

Referring to FIGS. 9 and 10, when the access hatch 146 is in the open position, one or more components of the inner cavity 110 are exposed. In some embodiments, the access hatch 146 is at least partially aligned with the drum 116 and/or the motor 114. In such an arrangement, at least a portion of the drum 116 and/or the motor 114 may overlap with the access hatch 146. For example, opening the access hatch 146 may allow for the operator to access components of the central cavity 124, such as the drum 116 and/or the motor 114. The operator may open the access hatch 146 to perform maintenance on the cable puller 100. In some embodiments, the operator may open the access hatch 146 to remove a damaged cable from the drum 116 for replacement. For example, opening the access hatch 146 provides access to the drum hole 121 used to secure the cable to the drum 116.

In some embodiments, the cable puller 100 includes circuitry (e.g., actuators, sensors, locking mechanisms, controllers, etc.) to monitor the position of the access hatch 146 and adjust settings of the cable puller 100 based on the position of the access hatch 146. The cable puller 100 may include one or more sensors to detect whether the access hatch 146 is in the open position or the closed position. If the access hatch 146 is in the open position, the cable puller 100 may be restricted from receiving electricity to operate the motor 114. Once the sensors detect that the access hatch 146 is closed and/or locked, the cable puller 100 may be allowed to receive electricity to operate the motor 114. In some embodiments, the position of the access hatch 146 may allow or restrict the motor 114 from receiving electricity, regardless of the position of the power switch 140. For example, when the power switch 140 is in the first position (e.g., to allow the motor 114 to receive electricity), and the access hatch 146 is in the open position, the motor 114 may be restricted from receiving electricity. Once the access hatch 146 is locked in the closed position, the power switch 140 may then allow the motor 114 to receive electricity.

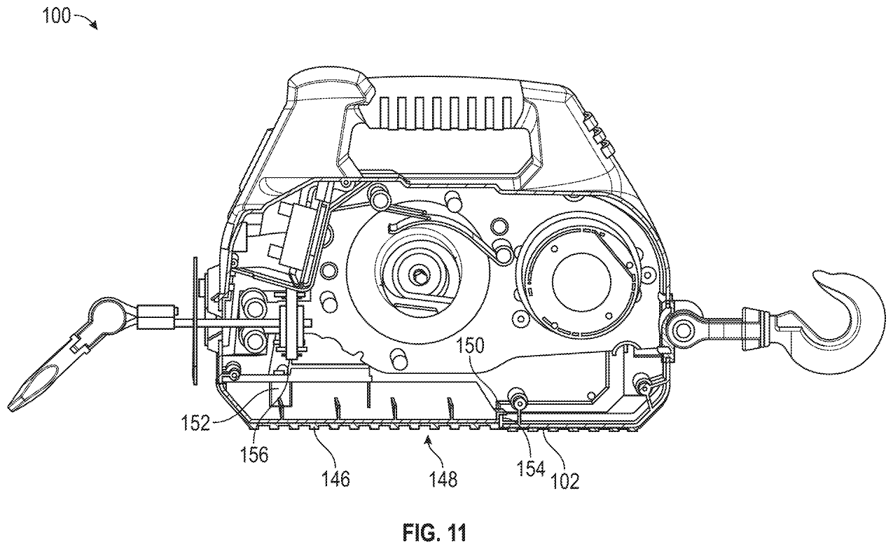

Referring to FIG. 11, the access hatch 146 may be removably coupled to the bottom portion 148 of the housing 102. The access hatch 146 is shown to include an attachment tab 150 and a fastener interface 152. The housing 102 may include a tab 154 perpendicularly coupled to an interior surface of the bottom portion 148 of the housing 102. The attachment tab 150 may be curved (e.g., angled, L-shaped, etc.) such that a top portion of the attachment tab 150 can be positioned over the tab 154. When the attachment tab 150 is placed over the tab 154, a side of the access hatch 146 may be flush (e.g., aligned) with a side surface of the housing 102 such that the fastener interface 152 is aligned with a fastener opening 156 of the housing 102. This may allow for improved ease of coupling between the access hatch 146 and the housing 102, as proper alignment of the housing 102 and the access hatch 146 can be achieved by placing the attachment tab 150 over the tab 154 (e.g., as opposed to user approximations).

The fastener interface 152 is shown to include an opening (e.g., hole) extending through the access hatch 146. The fastener interface 152 may be threaded, such that a fastener (e.g., screw, bolt, etc.) can be inserted through the fastener interface 152. The fastener opening 156 may be capable of accepting a fastener inserted through the fastener interface 152, thereby coupling the access hatch 146 to the housing 102. For example, when the fastener interface 152 and the fastener opening 156 are aligned (e.g., due to the attachment tab 150 being placed over the tab 154), a fastener may be placed (e.g., threaded, inserted) through the fastener interface 152, and couple with the fastener opening 156, thereby coupling the access hatch 146 to the housing 102.

Additionally, or alternatively, the cable puller 100 may include one or more locking mechanisms configured to automatically lock the access hatch 146 in the closed position while the motor 114 is operating (e.g., the front end 142 or rear end 144 of the rocker switch 134 is below the actuation axis 145). This may ensure that the operator does not interact with the drum 116 while the drum 116 is rotating. Once the motor 114 is in neutral mode (e.g., the front end 142 and rear end 144 of the rocker switch 134 is above the actuation axis 145), the locking mechanism may automatically unlock, allowing the operator to open the access hatch 146.

While the access hatch 146 is described with respect to the cable puller 100 shown in FIGS. 9, 10, and 11, the access hatch 146 and corresponding structure may be included in any embodiment, including the cable puller 100 shown in FIGS. 3 and 4.

It should be noted that the terms “exemplary” and “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

It is important to note that the construction and arrangement of the systems as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

What is claimed is:

1. A cable puller, comprising:
a housing comprising an inner cavity;
a frame disposed within the inner cavity and dividing the inner cavity into a central cavity with a first outer cavity on a first side of the central cavity and a second outer cavity on a second side of the central cavity opposite the first side;
a rotatable drum partially disposed within the central cavity;
a motor partially disposed within the central cavity;
a set of transfer gears coupled between the motor and the rotatable drum, the set of transfer gears partially disposed in one of the first outer cavity or the second outer cavity; and
a planetary gear assembly coupled between the motor and the rotatable drum, the planetary gear assembly partially disposed in the other of the first outer cavity or the second outer cavity.

2. The cable puller of claim 1, wherein the motor is disposed in a rear portion of the central cavity, and the rotatable drum is disposed in a front portion of the central cavity.

3. The cable puller of claim 1, wherein the frame comprises a first vertical plate and a second vertical plate extending a length of the inner cavity, and wherein the central cavity is positioned between the first vertical plate and the second vertical plate.

4. The cable puller of claim 3, wherein the first vertical plate and the second vertical plate each comprise one or more openings to allow the motor to couple to the set of transfer gears, the set of transfer gears to couple to the planetary gear assembly, and the planetary gear assembly to couple to the rotatable drum.

5. The cable puller of claim 3, the first outer cavity is defined by a first distance extending laterally from the first vertical plate to a first wall of the inner cavity, and the second outer cavity is defined by a second distance extending laterally from the second vertical plate to a second wall of the inner cavity.

6. The cable puller of claim 1, wherein the set of transfer gears are coupled to the planetary gear assembly via a transfer shaft extending through the rotatable drum.

7. The cable puller of claim 6, wherein the rotatable drum comprises a channel extending between the first outer cavity and the second outer cavity.

8. The cable puller of claim 7, wherein the transfer shaft extends within the channel.

9. The cable puller of claim 1, comprising an access hatch disposed on a bottom portion of the housing and configured to move between an open position and a closed position, wherein, in the open position, the access hatch is configured to facilitate access to the inner cavity.

10. The cable puller of claim 1, wherein the motor is disposed in a front portion of the central cavity, and the rotatable drum is disposed in a rear portion of the central cavity, and wherein a top surface of a base of the rotatable drum is positioned above a top surface of the motor.

11. A cable puller, comprising:
a housing comprising an inner cavity;
a frame disposed within the inner cavity;
a rotatable drum disposed within the inner cavity;
a motor disposed within the inner cavity;
a set of transfer gears coupled between the motor and the rotatable drum, the set of transfer gears disposed in the inner cavity;
a planetary gear assembly coupled to the set of transfer gears and disposed in the inner cavity; and
an access hatch disposed on a bottom portion of the housing and configured to move between an open position and a closed position;
wherein the access hatch is configured to facilitate access to a portion of the inner cavity.

12. The cable puller of claim 11, wherein the access hatch is decoupled from the housing in the open position.

13. The cable puller of claim 11, wherein the access hatch is moveably coupled to the housing.

14. The cable puller of claim 13, wherein the access hatch is at least partially aligned with the rotatable drum.

15. The cable puller of claim 13, wherein the access hatch is removably coupled to the housing via a threaded fastener.

16. A cable puller, comprising:
a housing comprising an inner cavity, the inner cavity comprising:
a rotatable drum;
a motor; and
a gear assembly coupling the motor to the rotatable drum;
a handle positioned on a top portion of the housing, the handle configured to be gripped by an operator; and
a rocker switch positioned at a front portion of the handle and electronically coupled to the motor, wherein an actuation axis of the rocker switch is aligned with a longitudinal axis of the handle.

17. The cable puller of claim 16, wherein the rocker switch is configured to switch between a first position, a second position, and a third position, wherein the first position corresponds to movement of the motor in a first direction, the second position corresponds to the motor being in a neutral setting, and the third position corresponds to movement of the motor in a second direction.

18. The cable puller of claim 17, comprising an access hatch disposed on a bottom portion of the housing and configured to move between an open position and a closed position, wherein responsive to the rocker switch being in the first position or the third position, the access hatch is locked in the closed position until the rocker switch is in the second position.

19. The cable puller of claim 18, wherein the rocker switch is positioned such that a hand of the operator used to grip the handle can simultaneously interact with the rocker switch.

20. The cable puller of claim 18, comprising a power switch configured to allow or restrict the motor from receiving electricity, wherein when the power switch is allowing the motor to receive the electricity, the access hatch is locked in the closed position.
